(19) United States
(12) Patent Application Publication
(10) Pub. No.: US 2006/0021436 A1
(43) Pub. Date: Feb. 2, 2006

(54) Multiaxial monolithic acceleration sensor

(76) Inventors: Konrad Kapser, Muenchen (DE); Ulrich Prechtel, Muenchen (DE); Helmut Seidel, Starnberg (DE)

Correspondence Address: FASSE PATENT ATTORNEYS, P.A., P.O. BOX 726, HAMPDEN, ME, 04444-0726, US

(21) Appl. No.: 10/517,808

(22) PCT Filed: Jun. 10, 2003
(86) PCT No.: PCT/DE03/01922

§ 371 Date: Jul. 28, 2005

(30) Foreign Application Priority Data
Jun. 11, 2002 (DE) 102 25 714.0

(51) Int. Cl. G01P 15/18; G01P 15/02

(52) U.S. Cl. 73/514.38; 73/514.01

(57) ABSTRACT

A multi-axial monolithic acceleration sensor has the following features. The acceleration sensor consists of plural individual sensors with respectively a main sensitivity axis arranged on a common substrate. Each individual sensor is rotatably moveably suspended on two torsion spring elements and has a seismic mass with a center of gravity. Each individual sensor has components that measure the deflection of the seismic mass. The acceleration sensor preferably consists of at least three identical individual sensors. Each individual sensor is suspended eccentrically relative to its center of gravity and is rotated by 90°, 180° or 270° relative to the other individual sensors.

The invention relates to a tri- or bi-axial monolithic acceleration sensor according to the preamble of the patent claim 1 or 3 respectively.

From the U.S. Pat. No. 6,122,965 A, or from the corresponding German Patent DE 196 49 715 C2, an arrangement for measuring accelerations is known, which consists of four single or independent individual sensors arranged in a rectangle on a common substrate and respectively having a main sensitivity axis. Each individual sensor comprises a paddle with a center of gravity as a seismic mass. The main sensitivity axes of the respective individual sensors respectively comprise an error angle or displacement angle relative to the normal of the substrate surface. The direction of each rectangle side and the associated main sensitivity axis respectively span a plane, and the planes of the individual sensors lying on a diagonal are tilted or angled toward one another.

In this context it is disadvantageous that the error angle between a main sensitivity axis and the normal to the substrate surface is only adjustable in a limited range of at most 20°.

From the PCT application WO 89/05459, a micromechanical accelerometer is known, in which, for the detection of multi-dimensional motion changes, three micromechanical sensors that are respectively sensitive for the acceleration in one selected direction are monolithically integrated in a crystal. The sensors consist of torsion beams with eccentrically mounted masses, which exert torques or rotational moments about the axes of the torsion beams in connection with motion changes. The torques or rotational moments are measured with the aid of integrated piezo-resistances.

This accelerometer comprises individual elements of different construction principles with respect to the X- and Y-axis or the Z-axis. That results in different characteristics with respect to sensitivity, frequency response characteristic, or damping behavior. Furthermore, high demands are made on the evaluation electronics, which nearly precludes the application in vehicles.

It is the underlying object of the invention to embody an acceleration sensor according to the preamble of the claim 1 or 3 respectively such that a larger error angle is adjustable and the signals of the individual sensors can quickly and simply be evaluated.

This object is achieved by a tri- or bi-axial monolithic acceleration sensor with the characteristic features set forth in the claim 1 or 3.

The subject matter of the claim 1 or 3 comprises the advantages that a larger and also ideal error angle of 45° is adjustable, and the measurement principle that is designed or laid-out for planar differential capacitive signal read-out leads to especially stable sensors.

The invention is especially suitable for high-quality, offset-stable capacitive sensors for use in vehicles.

Advantageous embodiments of the acceleration sensor according to claim 1 or 3 are set forth in the dependent claims.

The invention will now be explained in connection with an example embodiment, with the aid of the drawing.

It is shown by

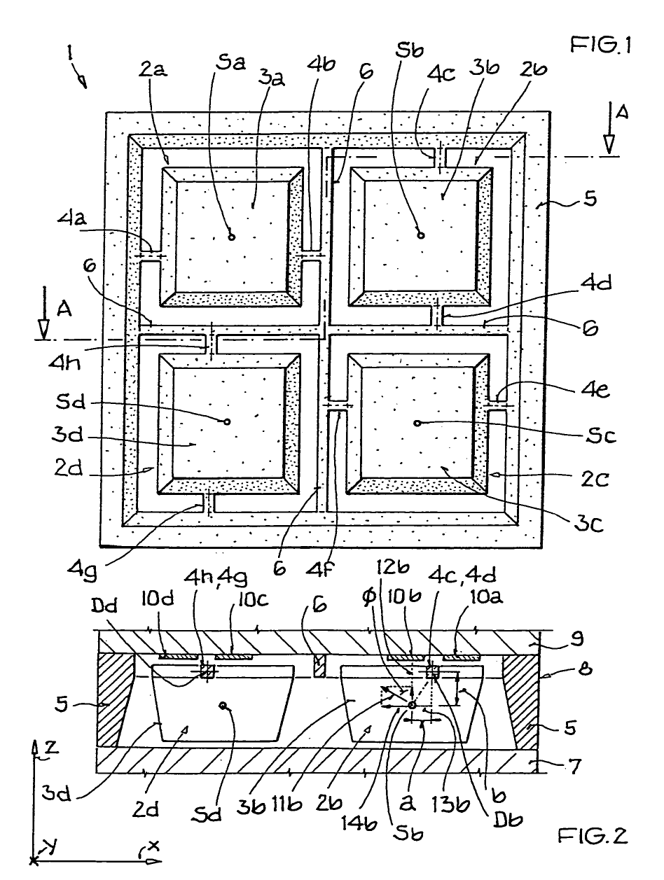

FIG. 1 a top plan view onto an inventive acceleration sensor consisting of four identical individual sensors on a common substrate,

FIG. 2 a sectional illustration through the arrangement according to FIG. 1 with two individual sensors and their seismic masses,

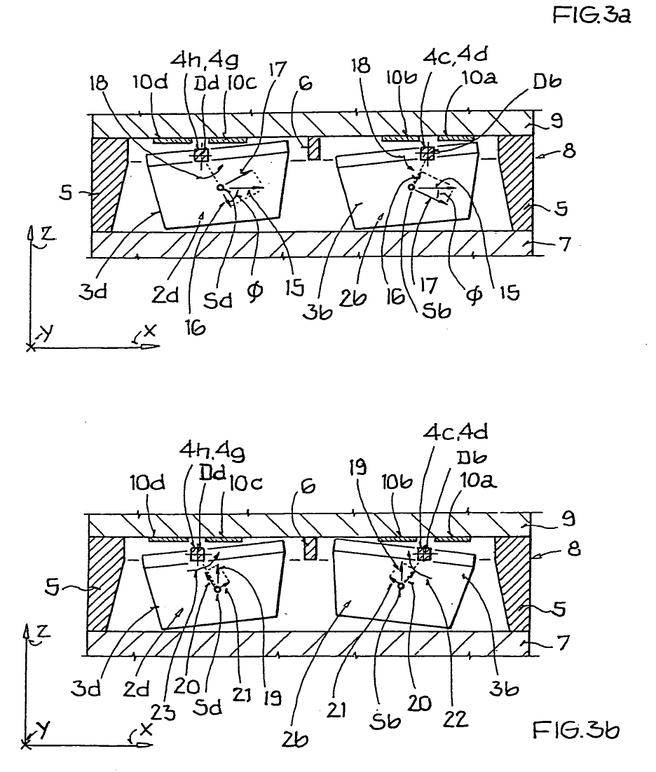

FIG. 3a: the deflection of the seismic masses of the individual sensors according to FIG. 2 as a result of an accelerating force acting in the X-direction, and

FIG. 3b: the deflection of the seismic masses of the individual sensors according to FIG. 2 as a result of an accelerating force acting in the Z-direction.

The FIG. 1 shows an acceleration sensor 1 for tri-axial measurement of accelerations, consisting of four identical individual sensors 2a, 2b, 2c and 2d. Each individual sensor 2a-d comprises a seismic mass 3a, 3b, 3c or 3d with a center of gravity Sₐ, S_{b}, S_{c} and S_{d}, whereby each seismic mass 3a-d is suspended eccentrically relative to its center of gravity Sₐ, S_{b}, S_{c} and S_{d} on two torsion spring elements 4a, 4b, 4c, 4d, 4e, 4f, 4g or 4h in a rotatably movable manner. Each torsion spring element 4a-g is on its part in turn connected with an outer frame 5. The outer frame 5 holds together the four individual sensors 2a-d and is divided by an intermediate frame 6.

An arrangement consisting of only two individual sensors 2a and 2c or 2b and 2d can be used as a sensor element for the measurement of bi-axial accelerations; for the measurement of tri-axial accelerations at least three of the four individual sensors 2a-d are needed. Each individual sensor 2a-d is rotated by 90°, 180° and 270°, generally a multiple of 90°, relative to the three other individual sensors 2a-d. In connection with the use of all four individual sensors 2a-d, a redundant information is present, which enables a permanent consistency testing of the output signals.

In FIG. 2, the acceleration sensor 1 of the FIG. 1 is illustrated in the section A-A. A disk that consists of silicon and that is structured in a known micromechanical manner is arranged as a common substrate 8 of the four individual sensors 2a-d between a lower cover disk 7 and an upper cover disk 9, and is connected with these, for example by wafer bonding, whereby the lower cover disk 7 and the upper cover disk 9 similarly consist of silicon. By means of an etching process, the seismic masses 2a-d of the individual sensors 3a-d, the torsion spring elements 4a-h and the intermediate frame 6 are structured or patterned into the disk 8.

Metallized surfaces 10a, 10b, 10c and 10d that are insulated or isolated from one another are structured or patterned on the inner side of the upper cover disk 9 over each seismic mass 3 and preferably symmetrically relative to the torsion axis defined by the respective torsion spring element 4. These surfaces serve for the differential capacitive measurement of the rotational motion of a seismic mass 3 under the influence of an acceleration force.

Each seismic mass 3a-d comprises a main sensitivity axis 11 extending through the respective center of gravity or mass Sₐ, S_{b}, S_{c} and S_{d}. The main sensitivity axis 11 is illustrated on the individual sensor 2b with the main sensitivity axis 11b and applying analogously for the individual sensors 2a, 2c and 2d, the direction of which does not extend parallel to a respective normal 12b due to the one-sided suspension of the seismic mass 3b and due to the offset or shifted-away center of gravity S_{b}.

The suspension of the seismic mass 3b on two torsion spring elements 4c, 4d gives rise to a rotation axis D_{b}, about which the seismic mass 3b rotates under the influence of an accelerating force. If one designates the spacing distance between the rotation axis D_{b} and the center of gravity S_{b} in the X-direction as spacing distance α, and the spacing distance between the rotation axis D_{b} and the center of gravity S_{b} in the Z-direction as spacing distance b, then the error angle φ is calculated as follows:

$$tan ϕ = \frac{b}{a} .$$

The error angle φ can be adjusted over wide limits via the form or embodiment of each seismic mass 3. Due to the identical construction, the error angle φ is equally large for all individual sensors 2a-d; suitable values for the error angle φ are freely adjustable or settable, even also an error angle φ of 45° as the ideal case in the orthogonal coordinate system. The principle is also generalizable, so that the individual sensors 2a-d can comprise different error angles φ.

In order to be able to measure acceleration forces acting in the X-, Y- and Z-direction, the main sensitivity axis 11b is separated or resolved into a component 13b parallel to the normal 12b and into a component 14b perpendicular to the normal 12b.

The statements made for the individual sensor 2b apply analogously also for the individual sensors 2a, 2c and 2d. As the individual sensors 2a-d and especially the seismic masses 3a-d comprise largely or substantially equal geometric dimensions as required by or conditioned on the fabrication process, respectively their sensitivity in the X-direction, their sensitivity in the Y-direction, and their sensitivity in the Z-direction is similarly substantially equal.

FIG. 3a shows the deflection of the seismic masses 3b and 3d of the individual sensors 2b and 2d according to FIG. 2 as a result of an accelerating force acting in the X-direction, which is illustrated by an arrow 15. The separating or resolving of the accelerating force 15 gives rise to a component 16 on the straight line through D_{d} and S_{d} and a component 17 perpendicular thereto. The component 17 leads to a rotational motion of the seismic mass 3b or 3d about the rotation axis D_{b} or D_{d,} which is detected by differential capacitive measurement by means of the metallic surfaces 10a and 10b or 10c and 10d. The magnitude of the accelerating force 15 acting on the sensor 1 is calculated by trigonometric equations.

In connection with an accelerating force 15 acting in the X-direction, the rotation motion of the seismic mass 3b or 3d about the rotation axis D_{b} or D_{d} is in the same direction according to an arrow 18, the seismic masses 3a and 3c (FIG. 1) experience no rotational motion.

In connection with an accelerating force acting in the Y-direction, the seismic masses 3a or 3c experience a rotational motion about the longitudinal axis of the torsion elements 4a and 4b or 4e and 4f, whereas in this case the seismic masses 3b or 3d experience no rotational motion about their rotational axis D_{b} or D_{d}.

FIG. 3b shows the deflection of the seismic masses 3b and 3d of the individual sensors 2b and 2d according to FIG. 2 as a result of an accelerating force acting in the Z-direction, illustrated by an arrow 19. Analogously to the example of the FIG. 3a, the separating or resolving of the accelerating force 19 gives rise to a component 20 on the straight line through D_{d} and S_{d} and a component 21 perpendicular thereto. The component 21 leads to a rotational motion of the seismic mass 3b or 3d about the rotation axis D_{b} or D_{d,} which once again is detected by differential capacitive measurement by means of the metallic surfaces 10a and 10b or 10c and 10d. The magnitude of the accelerating force 19 acting on the sensor 1 is calculated through trigonometric equations.

In connection with an accelerating force 19 acting in the Z-direction, the rotational motion of the seismic mass 3b or 3d about the rotation axis D_{b} or D_{d} is opposite or counter-directed according to an arrow 22 or 23 respectively. Moreover, the rotational motion of the seismic mass 3a (FIG. 1) is opposite or counter-directed relative to the rotation motion of the seismic mass 3c.

1. Tri-axial monolithic acceleration sensor (1), which comprises the following characteristic features:
a) the acceleration sensor (1) consists of plural individual sensors (2a-d) with respectively a main sensitivity axis (11) arranged on a common substrate (8),
b) each individual sensor (2a-d) is rotatably movably suspended on two torsion spring elements (4a-h) and comprises a seismic mass (3a-d) with a center of gravity (Sₐ, S_{b}, S_{c} and S_{d}),
c) each individual sensor (2a-d) comprises means for the measurement (10) of the deflection of the seismic mass (3a-d),
characterized in that
d) the acceleration sensor (1) consists of at least three identical individual sensors (2a-d),
e) each individual sensor (2a-d) is suspended eccentrically relative to its center of gravity (Sₐ, S_{b}, S_{c}, S_{d}) and
f) is rotated relative to the other individual sensors (2a-d) by 90°, 180° or 270°.

2. Acceleration sensor according to claim 1, characterized in that the at least three identical individual sensors (2a-d) are arranged in a rectangle.

3-7. (canceled)

8. Acceleration sensor according to claim 1, characterized in that the substrate (8) is arranged between a lower cover disk (7) and an upper cover disk (9) for the sealing and for the protection against environmental influences.

9. Acceleration sensor according to claim 1, characterized in that a measurement of the deflection of each seismic mass (3a-d) is achieved by means of a differential capacitive measurement.

10. Acceleration sensor according to claim 9, characterized in that metallized surfaces (10a-d) that are isolated from one another are structured on the upper cover disk (9) close to the torsion axis defined by the respective torsion spring element (4a-h) for the differential capacitive measurement.

11. Acceleration sensor according to claim 10, characterized in that the surfaces (10a-d) are arranged symmetrically to the torsion axis defined by the respective torsion spring element (4a-h).

12. Bi-axial monolithic acceleration sensor (1), that comprises the following characteristic features:
a) the acceleration sensor (1) consists of two individual sensors (2a-d) with respectively a main sensitivity axis (11) arranged on a common substrate (8),
b) each individual sensor (2a-d) is rotatably movably suspended on two torsion spring elements (4a-h) and comprises a seismic mass (3a-d) with a center of gravity (Sₐ, S_{b}, S_{c} and S_{d}),
c) each individual sensor (2a-d) comprises means for the measurement (10) of the deflection of the seismic mass (3a-d),
characterized in that
d) the acceleration sensor (1) consists of two identical individual sensors (2a-d),
e) each individual sensor (2a-d) is suspended eccentrically relative to its center of gravity (Sₐ, S_{b}, S_{c}, S_{d}) and is rotated by 180° relative to the other individual sensor (2a-d) and
f) the main sensitivity axis (11) of the one individual sensor (2a-d) extends vertically to the substrate (8) and the main sensitivity axis (11) of the other individual sensor (2a-d) extends vertically to the substrate (8).

13. Acceleration sensor according to claim 12, characterized in that the substrate (8) is arranged between a lower cover disk (7) and an upper cover disk (9) for the sealing and for the protection against environmental influences.

14. Acceleration sensor according to claim 12, characterized in that a measurement of the deflection of each seismic mass (3a-d) is achieved by means of a differential capacitive measurement.

15. Acceleration sensor according to claim 14, characterized in that metallized surfaces (10a-d) that are isolated from one another are structured on the upper cover disk (9) close to the torsion axis defined by the respective torsion spring element (4a-h) for the differential capacitive measurement.

16. Acceleration sensor according to claim 15, characterized in that the surfaces (10a-d) are arranged symmetrically to the torsion axis defined by the respective torsion spring element (4a-h).
